(19) United States
(12) Patent Application Publication
(10) Pub. No.: US 2009/0123147 A1
(43) Pub. Date: May 14, 2009

(54) Test Instrument For Testing Multi-Wavelength Optical Networks Using Two Or More Tunable Lasers

(75) Inventors: Hans-Joerg Wolf, Woodbine, MD (US); Andrew Mark Saunders, Gaithersburg, MD (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ACTERNA LLC, Germantown, MD (US)

(21) Appl. No.: 12/270,213

(22) Filed: Nov. 13, 2008

Related U.S. Application Data
(60) Provisional application No. 60/987,898, filed on Nov. 14, 2007.

(51) Int. Cl. H04B 10/08; H04B 17/00

(52) U.S. Cl. 398/16; 398/34; 398/26; 398/27

(57) ABSTRACT

The present invention relates to test equipment (e.g. TBERD 8000) with two or more Tunable Lasers (TL) for testing the complete spectrum of a DWDM system. Diagnostic software is used to stepwise tune a TL to a specific wavelength under test and simultaneously insert one or more distortion wavelengths while executing bit error and impairment tests on the wavelength under test. Information from these tests is correlated to create a combined DWDM network test report.

### CROSS-REFERENCE TO RELATED APPLICATIONS

The present invention claims priority from U.S. Provisional Patent Application No. 60/987,898 filed Nov. 14, 2007, which is incorporated herein by reference for all purposes.

### TECHNICAL FIELD

The field of the present invention lies within diagnosing and assessing the performance of an optical DWDM communications system for degradation due to various system conditions, including channel cross-talk and timing jitter.

### BACKGROUND OF THE INVENTION

With the evolution from Point-To-Point to reconfigurable dense wavelength division multiplex (DWDM) networks the complexity of calibrating, configuring, adjusting and maintaining such a DWDM network has greatly increased. Impairments due to various optical components comprising the network, such as insertion loss, chromatic and polarization mode dispersion as well as optical amplifier gain and noise, require precise selection and configuration of all devices and fiber within a single wavelength network path.

But even if each path in the DWDM network is performing well for a single wavelength, impairments may be encountered when a signal channel at a new wavelength is added to the network due to cross-talk or gain/amplification effects between the existing wavelengths. To monitor such impairments, test equipment needs to be connected to various points in the network for introducing test signals at given points and analyzing their effect on the performance of individual signal channels on the network. For carrying out tests over portions of the network, the test equipment must have established communication channels between them.

Present test equipment vendors already use “in-band” protocols to communicate between test equipment connected to various points on the network. Test equipment, which uses a single tunable laser to generate a test signal in a network, and then measures and analyzes the a single tunable laser to generate a test signal in a network, and then measures and analyzes the signal channels at single or multiple wavelengths, are known in the field (King et al., U.S. Pat. No. 7,386,231).

However, with only one tunable laser test signal, several types of impairments may not be synthesized or tested effectively. The present invention proposes a way for overcoming such deficiencies by employing several tunable optical sources.

### SUMMARY OF THE INVENTION

The present invention discloses a method for testing a multi-wavelength optical network with multiple signal channels using a wavelength selectable optical receiver, a bit error ratio tester and an optical transmitter comprising two or more tunable laser transmitters. The method comprises sequentially setting a first of the two or more tunable laser transmitters to each target wavelength of a list of target wavelengths to transmit a test pattern on the optical network.

For every target wavelength a second of the two or more tunable laser transmitters is set sequentially to emit every test signal on a list of test signals for transmission on the optical network. Each test signal comprises a distortion wavelength corresponding to a signal channel on the optical network, and a distortion level.

Performance impairment of the test pattern is then measured at the set target wavelength, which has been received with the optical receiver from the optical network in response to the test signals.

A final DWDM network test report is produced a at the conclusion of the tests, which contains measurement results for the received signal, the list of target wavelengths, the list of test signals and other configuration information.

A test system for an optical DWDM network is also described, which comprises a first tunable laser transmitter for generating a first output at a target wavelength, a first bit error ratio tester (BERT) for modulating the first tunable laser with a target test pattern, a second tunable laser transmitter for generating a second output at a distortion wavelength and a second bit error ratio tester (BERT) for modulating the second tunable laser with a distorting test pattern.

A DWDM multiplexer is provided for receiving and multiplexing the first and second outputs to transmit a multi-wavelength signal into the optical DWDM network. A DWDM demultiplexer coupled to the optical DWDM network is provided for receiving and demultiplexing the multi-wavelength signal to transmit a signal channel at the target wavelength. A receiver coupled to the DWDM demultiplexer receives the signal channel for evaluating the signal channel by a measuring and analysis function.

The test system may be incorporated in a portable test generator, such as a handheld instrument, for use in the field.

### BRIEF DESCRIPTION OF THE DRAWINGS

The invention will be described in greater detail with reference to the accompanying drawings which represent preferred embodiments thereof, wherein:

FIGS. 1a and 1b show the building blocks for a DWDM system test equipment in accordance with the present invention.

FIG. 2 gives an overview of a test system, indicating the basic components used in accordance with the present invention.

FIGS. 3a-3c show possible network scenarios in which the test equipment of FIGS. 1a and 1b can be used (TT—Tunable Transmitter, TR—Tunable Receiver).

FIG. 4 is a flow diagram representing a measurement method according to the present invention.

### DETAILED DESCRIPTION

The present invention relates to test equipment (e.g. TBERD 8000) with 2 or more tunable lasers (TL) which enable testing of the complete spectrum of a DWDM system and which uses suitable diagnostic software to stepwise tune one or more TLs to a specific wavelength under test. While simultaneously inserting several “distortion” wavelengths into a network, bit error and impairment tests on a particular wavelength under test are performed. Finally information from these tests is correlated in order to create a combined DWDM network test report.

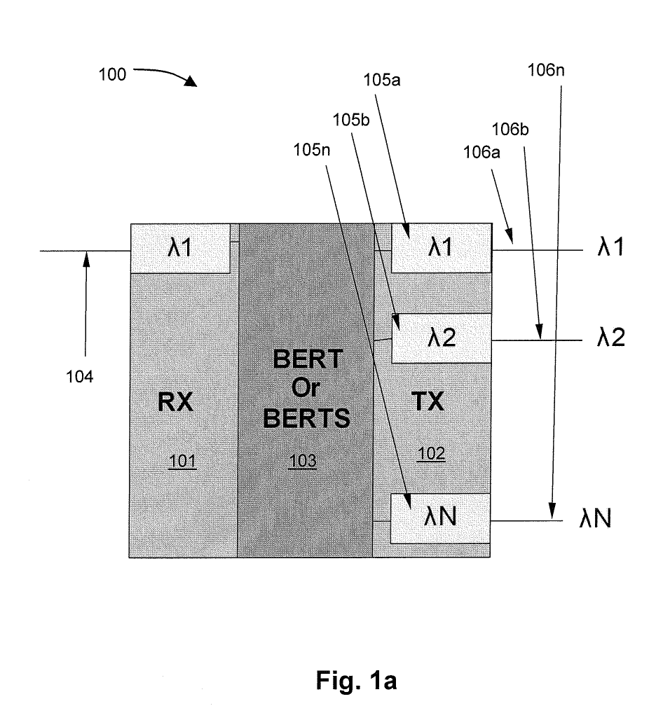

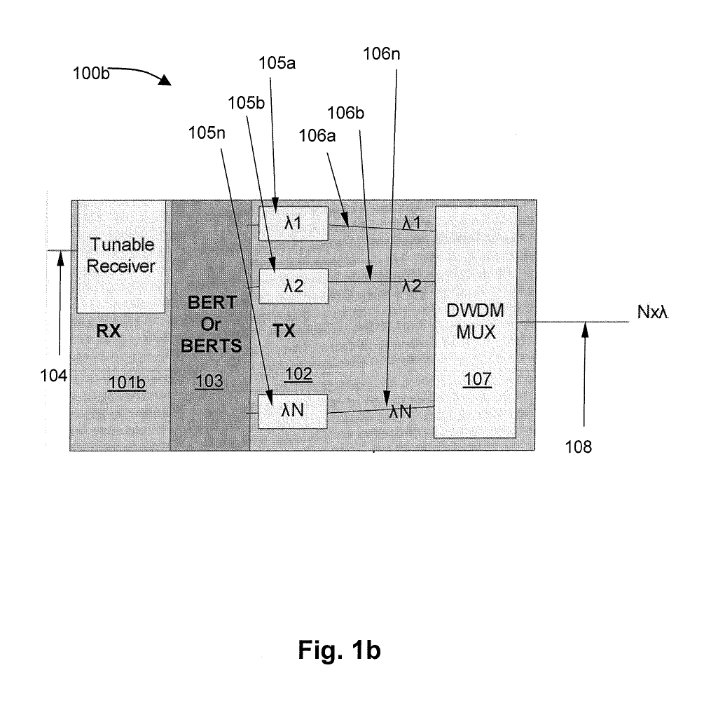

An example of a basic building block for a test system is shown in FIG. 1a. In test equipment 100, an optical signal with a wavelength denoted λ₁ is input into a receiver section 101 via an input port 104 for analysis in bit error ratio (BER) test unit 103. The BER test unit 103 generates test signals which are output into a transmitter section 102 comprising tunable lasers 105a, 105b, . . . 105n tuned to wavelengths λ₁, λ₂, . . . λₙ, which are output from output ports 106a, 106b, . . . 106n, respectively.

In another embodiment shown in FIG. 1b, a test equipment 100b is based on the test equipment 100, further comprising a DWDM multiplexing unit 107, combined with a tunable or wavelength selectable receiver 101b. The multiplexing unit 107 combines the outputs of tunable lasers 105a, 105b, . . . 105n tuned to wavelengths λ₁, λ₂, . . . λₙ, respectively, into a single multi-wavelength signal transmitted from output port 108.

Using test equipment with two (or more) tunable lasers described above, the proposed approach according to the present invention enables a user to test all available optical network paths and to predict the performance of a fully loaded DWDM network in which all available wavelengths are active.

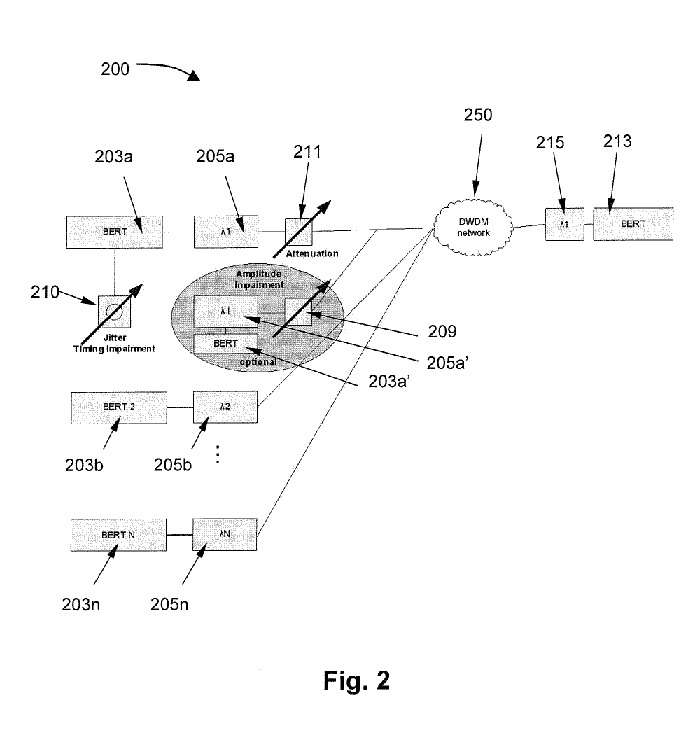

With reference to FIG. 2, test system 200 comprises two or more bit error ratio tester (BERT) units 203a, 203b, . . . 203n each connected to a tunable laser 205a, 205b, . . . 205n transmitting at wavelengths λ₁, λ₂, . . . λₙ, respectively, into a DWDM network 250. A DWDM demultiplexer or an optical filter 215 is connected to the DWDM network 250 for receiving an optical signal at wavelength λ₁, which is analyzed in BERT unit 213.

For some tests, a jitter and timing impairment generator 210 can be connected to the BERT unit 203a to introduce controlled distortions into the optical signal transmitted at wavelength λ₁ by the tunable laser 205a. For amplitude impairment tests, an additional BERT unit 203a′ may be introduced for controlling the signal transmitted by tunable laser 205a′ through variable optical attenuator 209 into the DWDM network 250. The additional BERT unit 203a′ transmits test patterns which may have a bit rate and bit pattern which differs from those of BERT unit 203a.

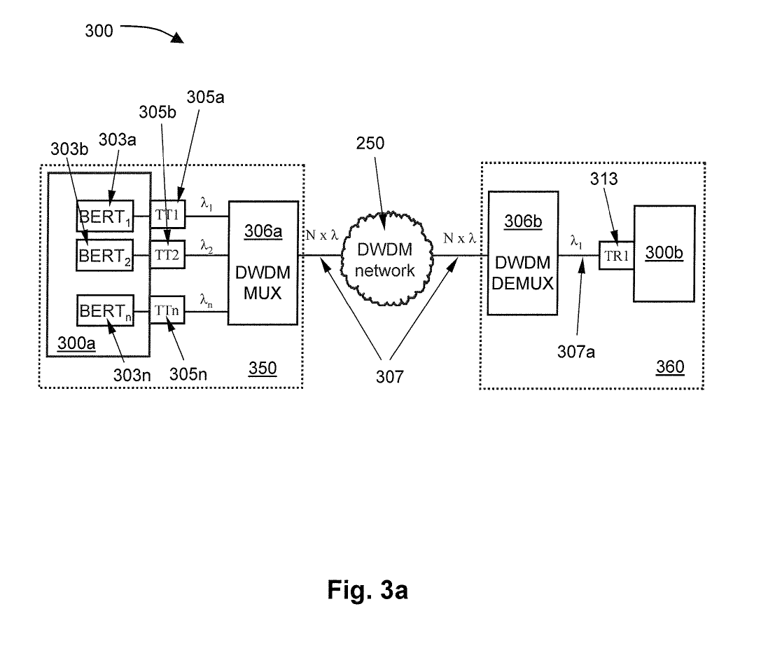

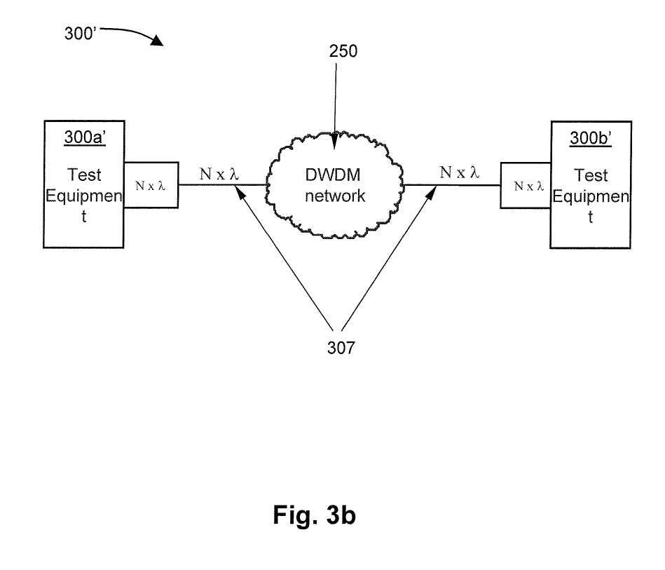

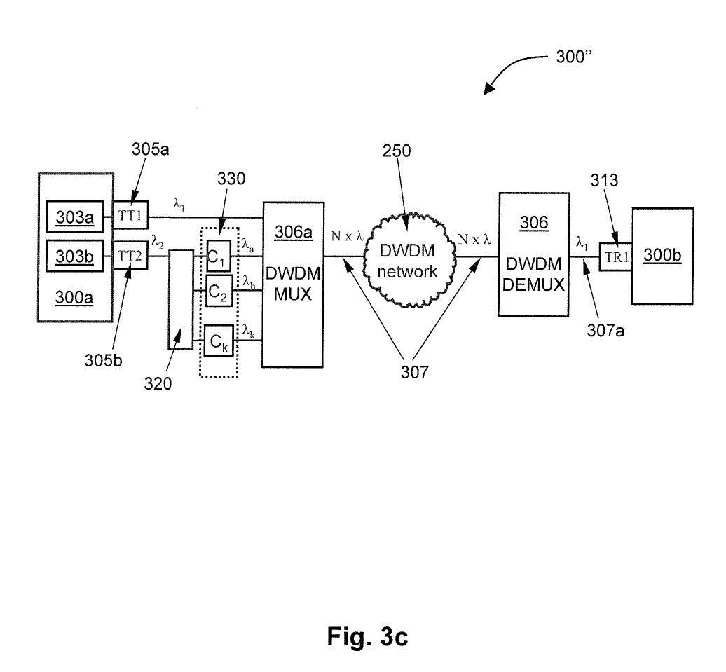

FIG. 3a illustrates an example of a test setup 300 in which two test equipment units 300a and 300b are used to insert and analyze test signals on the DWDM network 250. The test equipment unit 300a comprises two or more BERT units 303a, 303b, . . . 303n. The tunable laser transmitter 305a operating at a target wavelength λ₁ is modulated by the BERT unit 303a with a test signal before being multiplexed by a DWDM multiplexer 306a onto the DWDM network 250 via optical fiber 307. Similarly, one or more of the remaining tunable laser transmitters 305b, . . . 305n, may inject a similar or different test pattern at wavelengths λ₂, . . . λₙ, respectively, into the DWDM multiplex unit 306a, which combines them for transmission to the DWDM network 250 via the optical fiber 307. The respective test patterns may function as additional test signals or as distortion signals to simulate degraded network conditions due to faulty components or similar.

A multi-wavelength signal from the DWDM network 250 is received through optical fiber 307 by the DWDM demultiplex unit 306b, which splits the multi-wavelength signal into its constituent wavelength signal channels. One of the signal channels at a target wavelength λ₁ is transmitted over an optical channel 307a to a receiver 313 in the test equipment unit 300b. The test equipment unit 300b may be located locally with the test equipment units 300a, or at a remote location and vice versa.

A suitable protocol is implemented to configure various settings on the test equipment units 300a and 300b, such as target wavelengths, signal levels, timing, distortion wavelengths, distortion levels, etc., according to a particular selected setup, as well as to generate a test report at the conclusion of tests. The test report contains details of the test setup and measurement results for test equipment units 300a and 300b.

The test equipment unit 300a comprising the two or more BERT units 303a, 303b, . . . 303n can be preferably combined with the tunable lasers 205a, 205b, . . . 205n and the DWDM multiplex unit 306a into a single portable test generator unit 350. A complementary test receiver unit 360 could include the DWDM demultiplex unit 306b, the receiver 313 and the test equipment unit 300b.

An embodiment for receiving multiple wavelengths simultaneously for analysis is shown in FIG. 3b. The test equipment unit 300a′ generates and transmits a multi-wavelength test signal, possibly with simulated distortion, onto the DWDM network 250. This embodiment differs from the one previously described in FIG. 3a in that a test equipment unit 300b′ comprises a DWDM demultiplexer and a plurality of receivers, each measuring and analyzing a separate signal channel wavelength.

Another embodiment of a DWDM test setup 300″ involving the generation of multi-wavelength test signals is illustrated in FIG. 3c. In the test equipment unit 300a one of the tunable laser transmitters 305a is set to a target or test wavelength λ₁ and modulated with a test pattern with the BERT unit 303a, subsequent to which the target wavelength λ₁ is multiplexed by the DWDM multiplex unit 306a onto the DWDM network 250 via optical fiber 307. Output of another tunable laser transmitter 305b set to a wavelength 2 is modulated with a distorting test pattern by the BERT unit 303b and transmitted into a wavelength converter unit 330 which generates k output wavelengths λₐ, λ_{b}, . . . λₖ, each containing a replica of the distorting test pattern. The output wavelengths λₐ, λ_{b}, . . . λₖ generally correspond to signal channels on the DWDM network 250 and may include all or only a subset of the available signal channels. While only a single receiver 313 at λ₁ is shown for simplicity, the test equipment unit 300b may have more than one receiver up to the number of available channels on the DWDM network 250 to permit more comprehensive or faster network testing and evaluation.

The present invention provides a network operator with the capability to validate, troubleshoot and certify the network before customer traffic is deployed, as well as predicting the effects of introducing an additional signal channel at a specific new wavelength while other wavelengths of the network are already in-service. The test equipment is capable of transmitting and receiving single wavelength signals to and from the DWDM multiplexers as well as to transmit and receive multiple wavelength signals within a DWDM network.

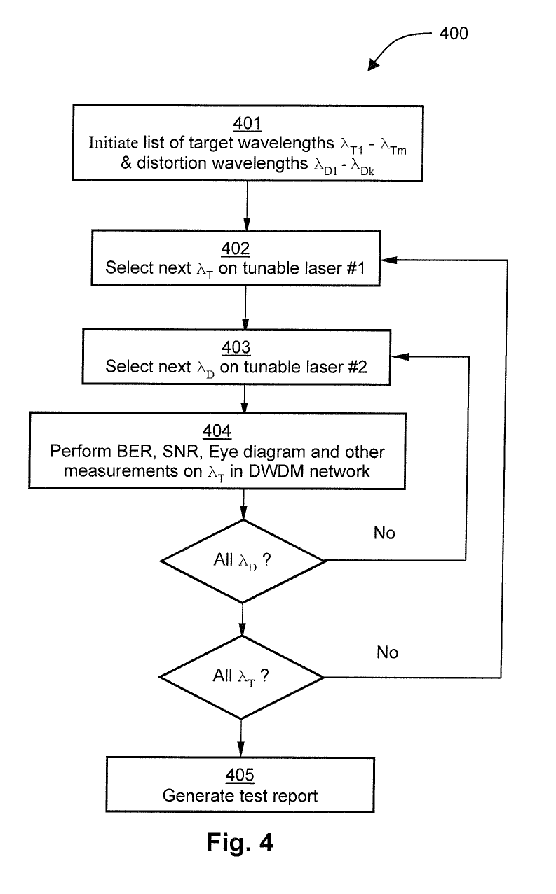

An example pseudo-algorithm 400 is now described on hand FIG. 4, which defines the steps performed by the test equipment during a turn-up application (i.e. in which none of the wavelengths is in use yet).

During a test setup step 401 the network operator configures a list of m target wavelengths λ_{T1}, λ_{T2}, . . . λ_{Tm} and k distortion wavelengths λ_{D1}, λ_{D2}, . . . λ_{Dk}. As a default, both the target wavelength list and the distortion wavelength list may include all available DWDM wavelengths as used in the DWDM network 250 (e.g. ITU grid). Although the following algorithm refers to only one distortion wavelength, λ_{D1}, for reasons of simplicity, when more than two tunable lasers are used, the algorithm can be modified to include multiple distortion wavelengths.

The first target wavelength in the list, λ_{T1}, is selected in step 402 for emission by tunable laser 305a on test equipment unit 300a for transmission onto the DWDM network 250 via an optical fiber 307. The tunable laser 305a may be set by a programmable controller using suitable software commands or algorithms. The remote or local test equipment unit 300b is configured to measure and record results pertinent to the first target wavelength, λ_{T1}, which is selected by an optical filter (not shown) or demultiplexed in the demultiplexer 306.

One distortion wavelength in the list, λ_{D1}, is then selected in step 403 for emission by a second tunable laser 305b on test equipment unit 300a for transmission onto the DWDM network 250 via an optical fiber 307. The distortion wavelength λ_{D1} will cause noise impairments and intermodulation distortion on the selected target wavelength, λ_{T1}.

Impairments such as jitter, attenuation, etc. are introduced on the target wavelength, λ_{T1} using, for instance, the previously described jitter and timing impairment generator 210 connected to BERT unit 303a test equipment unit 300a.

The effects of the distortion wavelength, λ_{DI}, as well as the impairments introduced on the target wavelength λ_{T1} are measured in step 404 with BERT measurements and Eye Diagram measurements on test equipment unit 300b′ and relevant results such as BER rate, signal to noise ratio (SNR) and similar are determined.

When testing at the selected distortion wavelength, λ_{D1}, is completed, the next available distortion wavelength is selected from the list and the testing repeated until all distortion wavelengths in the list λ_{D1}, λ_{D2}, . . . λ_{Dk} have been tested against the first target wavelength, λ_{T1}.

Once all testing has been completed for the first target wavelength, λ_{T1}, the next target wavelength in the list is selected and testing executed for all k distortion wavelengths λ_{D1}, λ_{D2}, . . . λ_{Dk}. Testing is continued until all m target wavelengths λ_{T1}, λ_{T2}, . . . λ_{Tm} have been covered.

In step 405 a final DWDM network test report is produced, which typically contains the list of target wavelengths, the list of distortion wavelengths, the list of test signals, and measurement results for the received signal for each combination of target and distortion wavelengths.

A variation of the above algorithm makes use of the setup illustrated in FIG. 3c. In place of the step-wise selection of distortion wavelengths in step 403, an output of the second tunable laser 305b on test equipment unit 300a is split and fed into the wavelength converter unit 330 which generates k distortion wavelengths λ_{D1}, λ_{D2}, . . . λ_{Dk}, as described above. A distorting test signal or bit pattern generated by the BERT unit 303b can thus be inserted into the DWDM network 250 at the distortion wavelengths λ_{D1}, λ_{D2}, . . . λ_{Dk}, along with the target wavelength λ_{T1}. An evaluation of noise impairments and intermodulation distortion on the selected target wavelength λ_{T1} due to the test signal or bit pattern at the distortion wavelengths λ_{D1}, λ_{D2}, . . . λ_{Dk} can thus be performed and a final DWDM network test report produced.

We claim:

1. A method for testing a multi-wavelength optical network with multiple signal channels using a wavelength selectable optical receiver, a bit error ratio tester and an optical transmitter comprising two or more tunable laser transmitters, the method comprising:
sequentially setting a first of the two or more tunable laser transmitters to each target wavelength of a list of target wavelengths to transmit a test pattern on the optical network;
for every target wavelength:
setting a second of the two or more tunable laser transmitters to sequentially emit every test signal on a list of test signals for transmission on the optical network, each test signal comprising a distortion wavelength corresponding to a signal channel on the optical network, and a distortion level; and
measuring a performance impairment of the test pattern at the set target wavelength received with the optical receiver from the optical network in response to the test signals; and
producing a final DWDM network test report containing measurement results for the received signal, the list of target wavelengths and the list of test signals.

2. The method of claim 1, further comprising, for each of the target wavelengths, stepwise locking the first tunable laser to each of the target wavelengths, and executing an acceptance test.

3. The method of claim 2, wherein a programmable controller is used to stepwise lock the first tunable laser to each of the target wavelengths.

4. The method of claim 1, further comprising using a programmable controller to configure the optical transmitter and optical receiver.

5. The method of claim 4, wherein the optical receiver and the optical transmitter are located remotely from one another.

6. The method of claim 5, further comprising retrieving test results from the remote location via an internal in-band protocol for inclusion in the final DWDM network test report.

7. A method for testing a multi-wavelength optical network with multiple signal channels using a wavelength selectable optical receiver, a bit error ratio tester and an optical transmitter comprising a first tunable laser, a second transmitter and plurality of wavelength converters, the method comprising:
configuring a list of target wavelengths, each corresponding to one of the signal channels on the optical network;
configuring a list of test signals, each test signal comprising a distortion wavelength corresponding to a signal channel on the optical network, and a distortion level;
sequentially setting the first tunable laser to each of the target wavelengths on the list of target wavelengths to transmit a test pattern on the optical network;
for every target wavelength:
setting the second tunable laser to sequentially emit every test signal on the list of test signals for transmission on the optical network;
converting the test signal to a plurality of converted frequencies with the plurality of wavelength converters to transmit a plurality of converted test patterns on the optical network; and
measuring a performance impairment of the test pattern at the set target wavelength received with the optical receiver from the optical network in response to the test signals; and
producing a final DWDM network test report containing measurement results for the received signal, the list of target wavelengths and the list of test signals.

8. A test system for an optical DWDM network comprising:
a first tunable laser transmitter for generating a first output at a target wavelength;
a first bit error ratio tester (BERT) for modulating the first tunable laser with a target test pattern;
a second tunable laser transmitter for generating a second output at a distortion wavelength;
a second bit error ratio tester (BERT) for modulating the second tunable laser with a distorting test pattern;
a DWDM multiplexer for receiving and multiplexing the first and second outputs to transmit a multi-wavelength signal into the optical DWDM network;
a DWDM demultiplexer coupled to the optical DWDM network for receiving and demultiplexing the multi-wavelength signal to transmit a signal channel at the target wavelength;
a receiver coupled to the DWDM demultiplexer for receiving the signal channel; and
a measuring and analysis function for evaluating the signal channel.

9. A portable test generator for an optical DWDM network comprising:
a first tunable laser transmitter for generating a first output at a target wavelength;
a first bit error ratio tester (BERT) for modulating the first tunable laser with a target test pattern;
a second tunable laser transmitter for generating a second output at a distortion wavelength;
a second bit error ratio tester (BERT) for modulating the second tunable laser with a distorting test pattern; and
a DWDM multiplexer for receiving and multiplexing the first and second outputs to transmit an output multi-wavelength signal into the optical DWDM network.
